(19) United States
(12) Patent Application Publication
(10) Pub. No.: US 2011/0167364 A1
(43) Pub. Date: Jul. 7, 2011

(54) METHODS AND APPARATUSES FOR IMPROVING APPLICATION STARTUP

(75) Inventors: Pasi Antero Pentikäinen, Tampere (FI); Pekka Aleksi Uotila, Tampere (FI)

(73) Assignee: Nokia Corporation

(21) Appl. No.: 12/652,508

(22) Filed: Jan. 5, 2010

(51) Int. Cl. G06F 3/048

(52) U.S. Cl. 715/764

(57) ABSTRACT

Methods and apparatuses are provided for improving application startup. A method may include determining, in response to a first loading of an application, an initial application user interface screen generated by the application. The method may further include directing storage of the initial application user interface screen. The method may additionally include detecting a second loading of the application. The method may also include directing display of the stored initial application user interface screen during at least a portion of the second loading of the application. Corresponding apparatuses are also provided.

### TECHNOLOGICAL FIELD

Embodiments of the present invention relate generally to application interface technology and, more particularly, relate to methods and apparatuses for improving application startup.

### BACKGROUND

The modern computing era has brought about a tremendous expansion in processing power and other capabilities of computing devices. Many computing devices now have sufficient capabilities to run increasingly complex applications and, often, to run multiple complex applications simultaneously. Further, expansion in computing technology has led to a reduction in scale of chips such that mobile computing devices now include much of the power and capabilities previously found only in the most powerful desktop and laptop computers. Accordingly, consumers may access and use many of their favorite applications from virtually any location using modern mobile computing devices.

However, in spite of the revolutionary increase in processing power, users still face a loading time delay between when an application is selected for startup and when the application is loaded and ready for use. Loading time delay is often some noticeable amount of time, which may comprise the time required for loading application instructions into memory and generating the application user interface for display once the instructions are loaded into memory. Loading time delay may be especially noticeable in performance limited mobile devices, which despite their dramatic advancements still often lag desktop computers in performance.

### BRIEF SUMMARY OF SOME EXAMPLES OF THE INVENTION

Methods, apparatuses, and computer program products are herein provided for improving application startup. In this regard, systems, methods, apparatuses, and computer program products are provided that may provide several advantages to computing devices and computing device users. Embodiments of the invention provide for determination and storage of an initial application user interface screen generated by an application when the application is first loaded. Embodiments of the invention display the stored initial application user interface screen during at least a portion of the next loading of the application. In this regard, embodiments of the invention give an application user the impression that the application is loaded more quickly. Further, earlier visualization of the initial user interface screen may orient the user to the application user interface such that the user may begin using the application more immediately when the application has become operation and its real user interface screen is displayed.

Embodiments of the invention additionally leverage the stored initial application user interface screen to make loading of an application a more seamless process. In this regard, embodiments of the invention provide for a transition effect, such as, for example, crossfading, between the stored initial application user interface screen and a runtime user interface screen generated by the application when the application has completed loading. Accordingly, the application user may perceive that the application has loaded more quickly as a seamless transition between a stored initial application user interface screen and a runtime user interface may give the perception that the application was loaded and operational upon display of the stored initial application user interface screen. Thus the application loading time perceived by the application user may be reduced by some embodiments of the invention.

In a first example embodiment, a method is provided, which comprises determining, in response to a first loading of an application, an initial application user interface screen generated by the application. The method of this embodiment further comprises directing storage of the initial application user interface screen. The method of this embodiment additionally comprises detecting a second loading of the application. The method of this embodiment also comprises directing display of the stored initial application user interface screen during at least a portion of the second loading of the application.

In another example embodiment, an apparatus is provided. The apparatus of this embodiment comprises at least one processor and at least one memory storing computer program code, wherein the at least one memory and stored computer program code are configured to, with the at least one processor, cause the apparatus to at least determine, in response to a first loading of an application, an initial application user interface screen generated by the application. The at least one memory and stored computer program code are configured to, with the at least one processor, further cause the apparatus of this embodiment to direct storage of the initial application user interface screen. The at least one memory and stored computer program code are configured to, with the at least one processor, additionally cause the apparatus of this embodiment to detect a second loading of the application. The at least one memory and stored computer program code are configured to, with the at least one processor, also cause the apparatus of this embodiment to direct display of the stored initial application user interface screen during at least a portion of the second loading of the application.

In another example embodiment, a computer program product is provided. The computer program product of this embodiment includes at least one computer-readable storage medium having computer-readable program instructions stored therein. The program instructions of this embodiment comprise program instructions configured to determine, in response to a first loading of an application, an initial application user interface screen generated by the application. The program instructions of this embodiment further comprise program instructions configured to direct storage of the initial application user interface screen. The program instructions of this embodiment additionally comprise program instructions configured to detect a second loading of the application. The program instructions of this embodiment also comprise program instructions configured to direct display of the stored initial application user interface screen during at least a portion of the second loading of the application.

In another example embodiment, an apparatus is provided that comprises means for determining, in response to a first loading of an application, an initial application user interface screen generated by the application. The apparatus of this embodiment further comprises means for directing storage of the initial application user interface screen. The apparatus of this embodiment additionally comprises means for detecting a second loading of the application. The apparatus of this embodiment also comprises means for directing display of the stored initial application user interface screen during at least a portion of the second loading of the application.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a block diagram of an apparatus for facilitating content-based image retrieval according to an example embodiment of the present invention;

FIG. 3 is a schematic block diagram of a mobile terminal according to an example embodiment of the present invention;

FIG. 4 illustrates a process for loading an application as perceived by the user according to an example embodiment of the invention;

FIG. 5 illustrates a flowchart according to an example method for improving application startup according to an example embodiment of the invention;

FIG. 6 illustrates a flowchart according to an example method for improving application startup according to an example embodiment of the invention; and

FIG. 7 illustrates a flowchart according to an example method for improving application startup according to an example embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

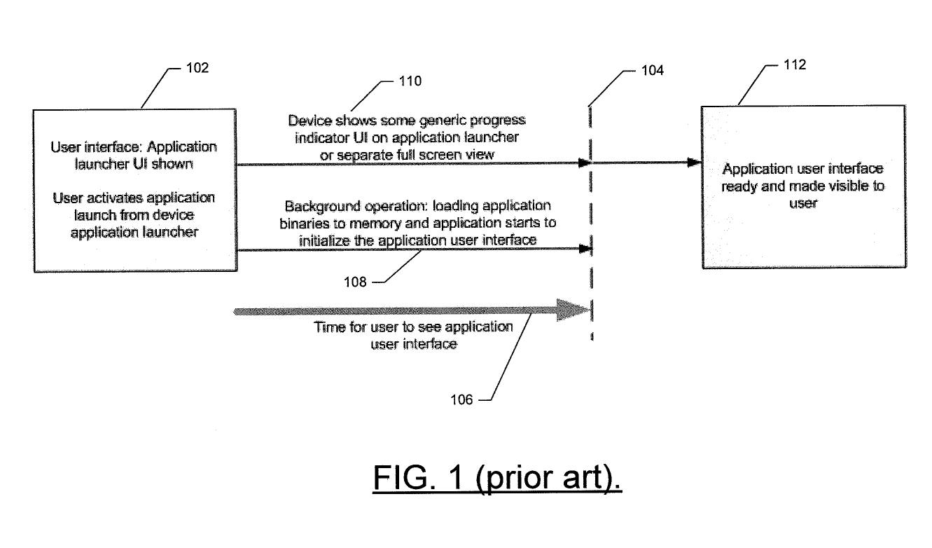

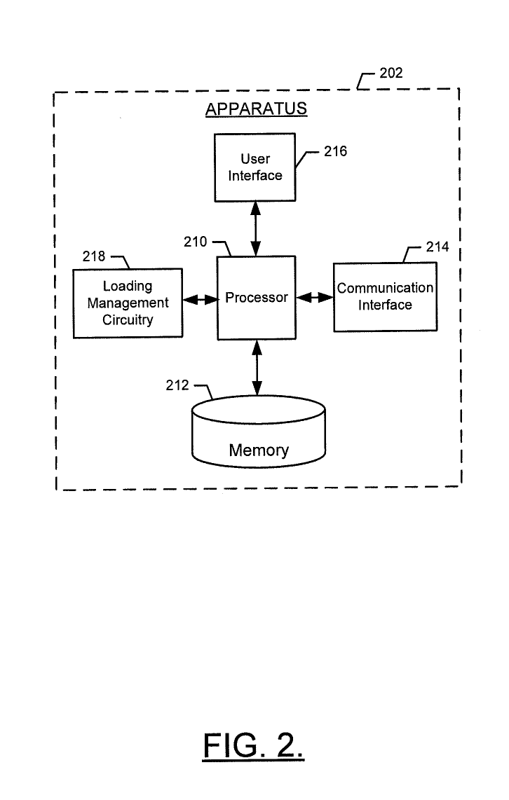

FIG. 1 illustrates a prior art process for loading an application as perceived by a user. An application launcher user interface may be displayed on a display of a user device. A user may select and launch an application by way of the application launcher user interface, at operation 102. In response to launching of the application, the device may load the application. However, the application user interface may not be available until a time 104 when the application has been loaded (e.g., the application binaries have been loaded into memory) and the application has completed generation of the application user interface. Accordingly, the loading time delay 106 between the time of launching the application at operation 102 and the time 104 represents the loading time delay before the user is able to see the application user interface. During the loading time delay 106, the device may load application binaries into memory in the background, at operation 108. Operation 108 may further comprise generation of the application user interface. While the application is loading, the device may display a generic loading progress indicator user interface or other splash screen to give notice to the user that the application is loading, at operation 210. The application user interface is not displayed to the user until operation 112 after the application binaries have been loaded into memory and the application has generated the user interface screen. Accordingly, from a user perspective, the user is not able to view any representation of the initial application user interface during the loading time delay 106. Thus the user may perceive a noticeable delay during the loading of the application and will not be oriented to the application user interface once the application has become operational following the time 104.

Embodiments of the invention provide methods, apparatuses, and computer program products for improving the application startup described with respect to FIG. 1. In this regard, embodiments of the invention may enhance user experience by reducing user perception of the loading delay that occurs during application startup and orienting the user to the application user interface in advance of the application becoming operational. FIG. 2 illustrates a block diagram of an apparatus 202 for improving application startup according to an example embodiment of the present invention. It will be appreciated that the apparatus 202 is provided as an example of one embodiment of the invention and should not be construed to narrow the scope or spirit of the invention in any way. In this regard, the scope of the invention encompasses many potential embodiments in addition to those illustrated and described herein. As such, while FIG. 2 illustrates one example of a configuration of an apparatus for improving application startup, numerous other configurations may also be used to implement embodiments of the present invention.

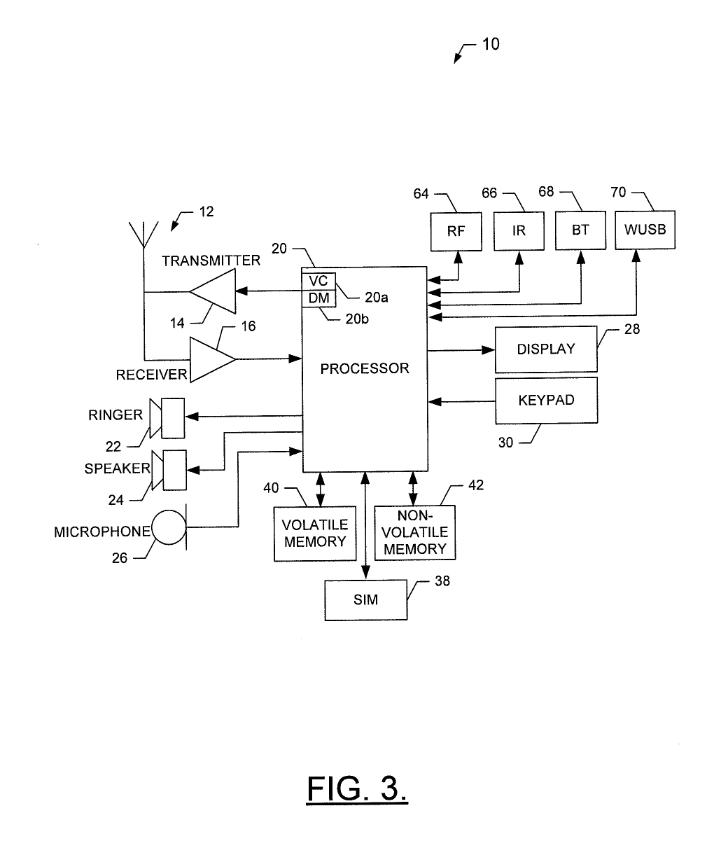

The apparatus 202 may be embodied as a desktop computer, laptop computer, mobile terminal, mobile computer, mobile phone, mobile communication device, one or more servers, one or more network nodes, game device, digital camera/camcorder, audio/video player, television device, radio receiver, digital video recorder, positioning device, any combination thereof, and/or the like. In an example embodiment, the apparatus 202 is embodied as a mobile terminal, such as that illustrated in FIG. 3.

In this regard, FIG. 3 illustrates a block diagram of a mobile terminal 10 representative of one embodiment of an apparatus 202 in accordance with embodiments of the present invention. It should be understood, however, that the mobile terminal 10 illustrated and hereinafter described is merely illustrative of one type of apparatus 202 that may implement and/or benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof Accordingly, although illustrated in FIG. 3 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 3, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 2, in an example embodiment, the apparatus 202 includes various means, such as a processor 210, memory 212, communication interface 214, user interface 216, and loading management circuitry 218 for performing the various functions herein described. These means of the apparatus 202 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 212) that is executable by a suitably configured processing device (e.g., the processor 210), or some combination thereof.

The processor 210 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 210 comprises a plurality of processors. The plurality of processors may be in operative communication with each other and may be collectively configured to perform one or more functionalities of the apparatus 202 as described herein. The plurality of processors may be embodied on a single computing device or distributed across a plurality of computing devices collectively configured to function as the apparatus 202. In embodiments wherein the apparatus 202 is embodied as a mobile terminal 10, the processor 210 may be embodied as or comprise the processor 20. In an example embodiment, the processor 210 is configured to execute instructions stored in the memory 212 or otherwise accessible to the processor 210. These instructions, when executed by the processor 210, may cause the apparatus 202 to perform one or more of the functionalities of the apparatus 202 as described herein. As such, whether configured by hardware or software methods, or by a combination thereof, the processor 210 may comprise an entity capable of performing operations according to embodiments of the present invention while configured accordingly. Thus, for example, when the processor 210 is embodied as an ASIC, FPGA or the like, the processor 210 may comprise specifically configured hardware for conducting one or more operations described herein. Alternatively, as another example, when the processor 210 is embodied as an executor of instructions, such as may be stored in the memory 212, the instructions may specifically configure the processor 210 to perform one or more algorithms and operations described herein.

The memory 212 may comprise, for example, volatile memory, non-volatile memory, or some combination thereof Although illustrated in FIG. 2 as a single memory, the memory 212 may comprise a plurality of memories. The plurality of memories may be embodied on a single computing device or may be distributed across a plurality of computing devices collectively configured to function as the apparatus 202. In various embodiments, the memory 212 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 202 is embodied as a mobile terminal 10, the memory 212 may comprise the volatile memory 40 and/or the non-volatile memory 42. The memory 212 may be configured to store information, data, applications, instructions, or the like for enabling the apparatus 202 to carry out various functions in accordance with example embodiments of the present invention. For example, in at least some embodiments, the memory 212 is configured to buffer input data for processing by the processor 210. Additionally or alternatively, in at least some embodiments, the memory 212 is configured to store program instructions for execution by the processor 210. The memory 212 may store information in the form of static and/or dynamic information. The stored information may include, for example, an image library including one or more images. This stored information may be stored and/or used by loading management circuitry 218 during the course of performing its functionalities.

The communication interface 214 may be embodied as any device or means embodied in circuitry, hardware, a computer program product comprising computer readable program instructions stored on a computer readable medium (e.g., the memory 212) and executed by a processing device (e.g., the processor 210), or a combination thereof that is configured to receive and/or transmit data from/to an entity. For example, the communication interface 214 may be configured to communicate with a remote server or other computing device through which an application may be accessed for use on the apparatus 202. As another example, in embodiments wherein the apparatus 202 comprises a server, network node, or the like, the communication interface 214 may be configured to communicate with a remote user terminal to allow a user of the remote user terminal to remotely access an application provided by the apparatus 202. In at least one embodiment, the communication interface 214 is at least partially embodied as or otherwise controlled by the processor 210. In this regard, the communication interface 214 may be in communication with the processor 210, such as via a bus. The communication interface 214 may include, for example, an antenna, a transmitter, a receiver, a transceiver and/or supporting hardware or software for enabling communications with one or more remote computing devices. The communication interface 214 may be configured to receive and/or transmit data using any protocol that may be used for communications between computing devices. In this regard, the communication interface 214 may be configured to receive and/or transmit data using any protocol that may be used for transmission of data over a wireless network, wireline network, some combination thereof, or the like by which the apparatus 202 and one or more remote computing devices are in communication. The communication interface 214 may additionally be in communication with the memory 212, user interface 216, and/or loading management circuitry 218, such as via a bus.

The user interface 216 may be in communication with the processor 210 to receive an indication of a user input and/or to provide an audible, visual, mechanical, or other output to a user. As such, the user interface 216 may include, for example, a keyboard, a mouse, a joystick, a display, a touch screen display, a microphone, a speaker, and/or other input/output mechanisms. In embodiments wherein the apparatus 202 is embodied as one or more servers, aspects of the user interface 126 may be reduced or the user interface 126 may even be eliminated. The user interface 216 may be in communication with the memory 212, communication interface 214, and/or loading management circuitry 218, such as via a bus.

The loading management circuitry 218 may be embodied as various means, such as circuitry, hardware, a computer program product comprising computer readable program instructions stored on a computer readable medium (e.g., the memory 212) and executed by a processing device (e.g., the processor 210), or some combination thereof and, in one embodiment, is embodied as or otherwise controlled by the processor 210. In embodiments wherein the loading management circuitry 218 is embodied separately from the processor 210, the loading management circuitry 218 may be in communication with the processor 210. The loading management circuitry 218 may further be in communication with one or more of the memory 212, communication interface 214, or user interface 216, such as via a bus.

A user may select to launch an application through an application launcher user interface displayed on a display operably connected to the apparatus 202. The display may, for example, comprise an element of the user interface 216. As another example, such as in embodiments wherein the apparatus 202 comprises a server, the display may comprise a display of a computing device remote to the apparatus 202 through which a user is accessing an application provided by the apparatus 202. The application launcher user interface may comprise any user interface by which an application may be launched. The application launcher user interface may comprise, for example, an interface of a dedicated application launcher utility. However, it will be appreciated that the application launcher user interface need not comprise a dedicated application launcher utility and may comprise any user interface through which a command may be entered to launch an application. For example, the application launcher user interface may comprise a user interface of an operating system through which an application may be selected and launched (e.g., a desktop environment provided by Microsoft Windows, a Linux operating system, and/or the like). As another example, the application launcher user interface may comprise a web browser through which a link to launch an application may be selected.

When the user selects to launch an application, the application may be loaded into a memory, such as, for example, the memory 212, to enable the application to be operational on the apparatus 202. In this regard, the application binaries may be loaded into the memory. Launching and loading of the application may, for example, be performed or otherwise controlled by the processor 210. The period between a user commanding launch of an application and the application becoming operational through completion of loading and generation and display of the application's user interface is sometimes referred to as application “startup” or “loading” time. “Loading” an application is used generally herein to refer to application startup time and may include, for example, loading the application binaries into memory, generation of the initial application user interface by the apparatus, and/or any other operations performed during application startup.

The loading management circuitry 218 may be configured to detect when an application is loading. In this regard, the loading management circuitry 218 may be configured to detect when a user selects to launch an application. Additionally or alternatively, the loading management circuitry 218 may be configured to detect loading of an application into memory. As a further example, the loading management circuitry 218 may be configured to detect an indication received from an application launcher, the application being loaded, and/or the like, that the application is being loaded.

The loading management circuitry 218 may be further configured to determine whether the detected loading is the first time the application has been loaded and/or if there is otherwise not a saved initial application user interface screen for the application being loaded. When there is not a saved initial application user interface screen for the application being loaded, the loading management circuitry 218 may be configured to direct display of a generic splash screen indicating that the application is being loaded. Alternatively, the loading management circuitry 218 may allow the application to display an application-specified splash screen while the application is being loaded.

The loading management circuitry 218 may be additionally configured to determine an initial application user interface screen generated by the application. The initial application user interface screen may comprise an initial user interface screen generated and presented by the application when the application has completed loading and becomes operational or just prior to the application becoming operational. The initial application user interface screen may accordingly comprise the user interface through which a user accesses and utilizes functionality provided by the application when operational.

The loading management circuitry 218 may be configured to determine the initial application user interface screen in accordance with any appropriate method. In one embodiment, the loading management circuitry 218 is configured to determine the first screen generated and presented by the application and identify that screen as the initial application user interface screen. Additionally or alternatively, in some embodiments, the loading management circuitry 218 is configured to use heuristics to identify and distinguish the initial application user interface screen from any non-user interface startup screens generated by the application during loading prior to generation of the initial user interface screen. In this regard, an application may, for example, generate one or more blank screens, single color screens, or other intermediary screens prior to generation of the initial user interface screen. Accordingly, the loading management circuitry 218 may, for example, be configured to use heuristics to ignore any screen that is blank or just has a single color when determining the initial user interface screen generated by the application.

As another example, the loading management circuitry 218 may be configured to determine an initial application user interface screen by determining an initial application user interface screen specified by an application programming interface (API) of the application. In this regard, an application developer may be aware of the existence and functionality of the loading management circuitry 218 and may configure an application to automatically provide an initial application user interface screen to the loading management circuitry 218 for use during a subsequent loading of the application. Accordingly, in embodiments wherein the loading management circuitry 218 is configured to determine an initial application user interface screen provided by an application, the application may be enabled to have more control over which user interface view is determined to be the initial application user interface screen by the loading management circuitry 218. Further, the application may be enabled to update the initial application user interface screen when application data has changed by providing an updated initial application user interface screen to the loading management circuitry 218 for use during the next loading of the application.

The loading management circuitry 218 is configured in some embodiments to direct storage of the determined initial application user interface screen in the memory 212. The loading management circuitry 218 may be configured to store the determined initial application user interface screen with an indication of the application with which it is associated so as to distinguish the stored initial application user interface screen from initial application user interface screens that may be stored for other applications. In order to save memory space and/or make the initial application user interface screen more resolution independent, the loading management circuitry 218 may be configured to store the initial application user interface screen in a vector graphics format, such as in a buffer. Additionally or alternatively, the loading management circuitry 218 may be configured, such as when an application renders bitmap-based images, to store the initial application user interface screen in a bitmap format. When storing an initial application user interface screen in a bitmap format, the loading management circuitry 218 may be configured to store the initial application user interface screen as a smaller size bitmap than the bitmap originally generated by the application. If an initial application user interface screen is not generated by the application in a bitmap format but the initial application user interface screen cannot be stored in a vector graphics format, the loading management circuitry 218 may be configured to rasterize the initial application user interface screen to a bitmap image prior to storing the initial application user interface screen.

The loading management circuitry 218 may be further configured to detect when an application for which an application user interface screen has been stored is subsequently loaded (e.g., loaded a second time). The loading management circuitry 218 may access the stored initial application user interface screen for the application in response to detecting loading of the application. In this regard, the loading management circuitry 218 may, for example, be configured to determine an identity of the application being loaded and then determine and access the stored initial application user interface screen associated with the identified application.

The loading management circuitry 218 is configured in some embodiments to direct display of the stored initial application user interface screen during at least a portion of the loading of the application. In this regard, the loading management circuitry 218 may be configured to direct display of the stored initial application user interface screen for at least a portion of the time between the user selecting to launch the application by the application launcher user interface and the application having been loaded into memory and generated an application user interface screen for the present runtime instance (e.g., the runtime user interface screen). Accordingly, the user may be presented with a view of the stored initial application user interface while the application is being loaded so as to give the user the impression that the application has loaded relatively quickly and to allow the user to orient himself to the initial application user interface prior to the application becoming operational.

In some embodiments the loading management circuitry 218 is configured to direct display of a transition effect between the user interface by which the application was launched and the stored initial application user interface screen. The transition effect may comprise any transition effect and may animate the transition from the application launcher user interface to the stored initial application user interface screen. In some embodiments, the saved initial application user interface screen may be used as a preview image for the application in the application launcher user interface. For example, the stored initial application user interface screen may be used as a selectable thumbnail by which the application may be launched. Accordingly, the transition effect between the application launcher user interface and the stored initial application user interface screen may, for example, comprise zooming into the thumbnail image. As another example, the loading management circuitry 218 may crossfade between the application launcher user interface and the stored initial application user interface.

The loading management circuitry 218 may be further configured to determine when the application has completed generation of the runtime user interface screen and is ready to display the screen. In response to this determination, the loading management circuitry 218 may cease display of the stored initial application user interface screen so that the application may display the runtime user interface screen such that the user may use the application.

In some embodiments, the loading management circuitry 218 is configured to direct display of a transition effect between the stored initial application user interface screen and the runtime user interface screen in response to completion of generation of the runtime user interface screen. The transition effect may comprise any transition effect, such as, for example, window flip, zoom out, crossfade, and/or the like. In an example embodiment, the loading management circuitry 218 is configured to direct display of a crossfade transition effect between the stored initial application user interface screen and the runtime user interface screen. This crossfade transition effect may be unnoticeable or at least relatively subtle so as to provide a smooth transition between the stored initial application user interface and runtime user interface and give the user the impression that it was the runtime user interface displayed while the stored initial application user interface screen was displayed. This smooth transition effect may accordingly heighten the appearance of an application loading quickly provided by embodiments of the invention.

In some instances, such as when an application being loaded is quite large or complex, there may be a relatively long delay between launch of the application and when the application has generated and is ready to render its runtime user interface screen. In such instances, displaying the stored application user interface screen without providing indication that the application is not yet operational may negatively impact user experience in that the user may be under the impression that the application is operational and attempt to provide operational input to the application when the application is still loading in the background. Accordingly, in some embodiments of the invention the loading management circuitry 218 is configured to direct display of an indication that the application is not yet operational during at least a portion of the time that the stored initial application user interface screen is displayed. For example, in embodiments wherein the loading management circuitry 218 directs display of a transition effect between the application launcher user interface and the stored initial application user interface screen, if at the time of completion of that transition effect, the application has not completed generation of the runtime user interface screen, the loading management circuitry 218 may direct display of an indication that the application is not yet operational. The indication that the application is not yet operational may comprise, for example, display of a grayed or otherwise color/alpha-modified version of the stored initial application user interface screen, display of a progress indicator indicating progress of the application loading until the application has completed generation of and rendered the runtime user interface screen, and/or other indication.

In some embodiments the loading management circuitry 218 is configured to determine and store an initial application user interface screen for an application only the first time the application is loaded and/or when there is otherwise not an appropriate stored initial application user interface screen for the application being loaded. However, some applications may be dynamic in that the initial user interface screen for the application may change over time dependent on content added to/removed from the application interface, elapse of time, and/or other factor. Accordingly, display of an outdated stored application user interface for such a dynamic application may not provide the desired effect of giving the user the indication that the application has loaded quickly and orienting the user to the current application user interface. The loading management circuitry 218 is configured in some embodiments to at least periodically update a stored initial application user interface screen. In this regard, the loading management circuitry 218 may be configured to update a stored initial application user interface screen periodically in accordance with a refresh policy that may define when a stored initial application user interface needs to be updated. The refresh policy may define, for example, that the stored initial application user interface screen is updated when the application has been loaded a predefined number of times since the stored initial application user interface screen was determined, when a predefined amount of time has passed since the stored initial application user interface screen was determined, and/or in accordance with a similar refresh policy. As another example, the loading management circuitry 218 may be configured to update a stored initial application user interface screen for an application every time the application is loaded.

When the loading management circuitry 218 updates a stored initial application user interface screen, the loading management circuitry 218 may determine a new initial application user interface screen in response to loading of the application. This determination may be performed in accordance with any of the methods previously described. The loading management circuitry 218 may then update the stored initial application user interface screen for the application by storing the new initial application user interface screen. In some embodiments, the loading management circuitry 218 may be configured, prior to storing the new initial application user interface screen, whether the new initial application user interface screen is different from the stored initial application user interface screen. In such embodiments, the loading management circuitry 218 may be configured to store the new initial application user interface screen when it is determined that the new initial application user interface screen is different from the stored initial application user interface screen.

The loading management circuitry 218 may be additionally configured to determine a screen mode of a determined initial application user interface screen In this regard, the initial application user interface screen may comprise a full screen mode screen, normal mode screen, or other mode. In normal mode case, a platform implemented on the apparatus 202, such as, for example, a Mobile Information Device Profile (MIDP) platform may render command menu buttons for menu actions on a command area of the screen. In full screen mode, the initial application user interface screen may cover an entirety of a display and the platform may not render command menu buttons. Accordingly, when the loading management circuitry 218 determines and stores an initial application user interface screen that comprises a normal mode screen, the loading management circuitry 218 may not store the command area as part of the stored initial application user interface screen. Thus, the loading management circuitry 218 may be configured to determine and consider a screen mode of an initial application user interface screen when storing the initial application user interface screen.

The loading management circuitry 218 may be further configured to store an indication of the determined screen mode in association with the initial application user interface screen when storing the initial application user interface screen. The loading management circuitry 218 may utilize the indication when directing display of the stored initial application user interface screen during a subsequent loading of the application to determine how to direct display of the stored initial application user interface screen. For example, when the loading management circuitry 218 directs display of a normal mode initial application user interface screen, the loading management circuitry 218 may be configured to direct display of a command area including a cancel-button allowing the user to cancel or stop the loading of the application. As another example, when the loading management circuitry 218 directs display of a full screen mode initial application user interface screen, the loading management circuitry 218 may be configured to direct display of the stored initial application user interface screen over an entirety of a display without directing display of a command area.

In some embodiments, the apparatus 202 may be configured to support orientation change of a display. In this regard, the apparatus 202 may, for example, be configured to change the orientation of an image displayed on the display in response to a change in orientation of the display. For example, when the display is positioned in a horizontal orientation, the apparatus 202 may be configured to display a user interface in a landscape orientation. When the display is positioned in a vertical orientation, the apparatus 202 may be configured to display a user interface in a portrait orientation. It will be appreciated that vertical and portrait orientation are provided merely for purposes of example and other orientations are possible in various embodiments of the invention.

The loading management circuitry 218 may accordingly be configured to support orientation change of a display in embodiments wherein the apparatus 202 is configured to support orientation change of a display. In this regard, the loading management circuitry 218 may be configured to store a plurality of initial application user interface screens for an application. Each stored initial application user interface screen for an application may be associated with an orientation. Thus, for example, the loading management circuitry 218 may be configured to store both an initial application user interface screen for portrait orientation and an initial application user interface screen for landscape orientation. When the loading management circuitry 218 directs display of a stored initial application user interface screen during loading of an application, the loading management circuitry 218 may determine the display orientation of the display and direct display of a stored application user interface screen associated with the determined display orientation. Further, if during loading the application, the display orientation is changed, the loading management circuitry 218 may be configured to change the displayed stored initial application user interface screen to another stored initial application user interface screen having an appropriate orientation for the current display orientation.

In some embodiments the loading management circuitry 218 is configured to determine a display orientation defining an orientation of a display on which an initial application user interface screen is displayed at a time when the initial application user interface screen is determined by the loading management circuitry 218. The loading management circuitry 218 may be further configured to direct storage of an indication of the determined display orientation in association with the initial application user interface when storing the initial application user interface.

When the loading management circuitry 218 detects loading of an application, the loading management circuitry 218 may be configured to determine a display orientation defining a current orientation of the display. The loading management circuitry 218 may determine whether there is a stored initial application user interface screen for the application being loaded that is associated with the same display orientation as the current display orientation. In this regard, the loading management circuitry 218 may be configured to compare the current display orientation with the display orientation with which a stored initial application user interface is associated to determine whether the display orientations are the same. When there is a stored initial application user interface screen associated with the appropriate display orientation, the loading management circuitry 218 may direct display of the appropriate stored initial application user interface screen.

When there is not a stored initial application user interface screen associated with the appropriate display orientation, the loading management circuitry 218 may be configured to direct display of an alternative stored initial application user interface screen having another orientation. Alternatively, the loading management circuitry 218 may direct display of a generic splash screen or allow the application to direct display of an application default splash screen. When the application has generated the initial application user interface screen for the current display orientation, the loading management circuitry 218 may determine the initial application user interface screen and direct storage of the initial application user interface screen for the current display orientation.

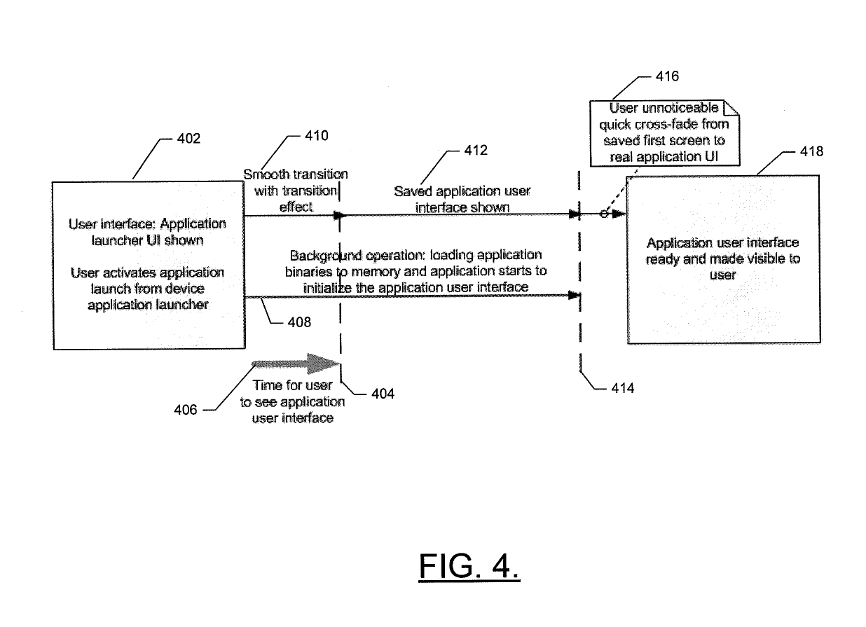

FIG. 4 illustrates a process for loading an application as perceived by the user according to an example embodiment of the invention. An application launcher user interface may be displayed on a display. A user may select and launch an application by way of the application launcher user interface, at operation 402. In response to launching of the application, the apparatus 202 may load the application the application binaries into memory in the background, at operation 408. Loading of the application is not completed until the time 414. From the user perspective, a transition effect may be displayed to transition between the application launcher user interface and a stored initial application user interface screen for the application, at operation 410. Accordingly, the time delay 406 before the user sees a user interface for the application is only until time 404 when the stored initial application user interface screen is displayed, at operation 412. This time delay 406 contrasts with the prior art approach illustrated in FIG. 1, wherein an application user interface screen for the application is not displayed until the application has completed loading (e.g., the time 414). After the application has been loaded and generated a runtime user interface screen, a cross fade transition effect from the saved initial application user interface screen to the runtime user interface screen may be displayed, in operation 416. The runtime application user interface may then displayed, at operation 418.

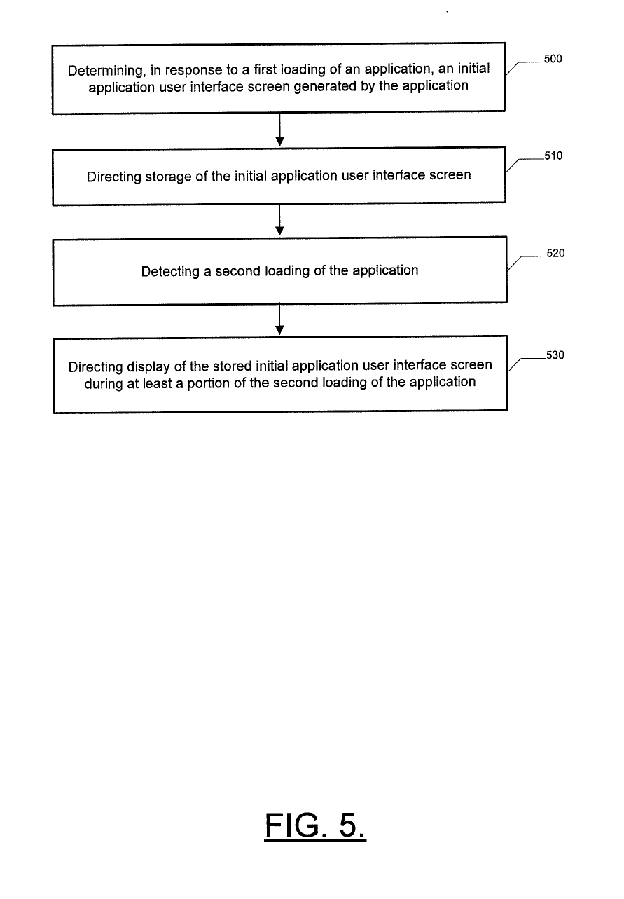

FIG. 5 illustrates a flowchart according to an example method for improving application startup according to an example embodiment of the present invention according to an example embodiment of the invention. The operations illustrated in and described with respect to FIG. 5 may, for example, be performed by and/or under the control of the loading management circuitry 218. Operation 500 may comprise determining, in response to a first loading of an application, an initial application user interface screen generated by the application. Operation 510 may comprise directing storage of the initial application user interface screen. Operation 520 may comprise detecting a second loading of the application. Operation 530 may comprise directing display of the stored initial application user interface screen during at least a portion of the second loading of the application.

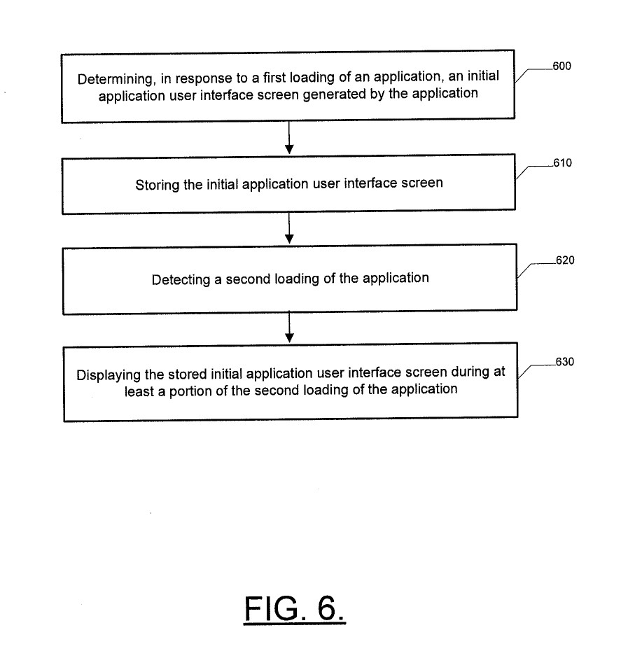

FIG. 6 illustrates a flowchart according to an example method for improving application startup according to an example embodiment of the invention. The operations illustrated in and described with respect to FIG. 6 may, for example, be performed by the apparatus 202. In this regard, the operations illustrated in and described with respect to FIG. 6 may, for example, be performed by and/or under the control of the processor 210, communication interface 214, user interface 216, loading management circuitry 218, or some combination thereof. Operation 600 may comprise determining, in response to a first loading of an application, an initial application user interface screen generated by the application. Operation 610 may comprise storing the initial application user interface screen. Operation 620 may comprise detecting a second loading of the application. Operation 630 may comprise displaying the stored initial application user interface screen during at least a portion of the second loading of the application.

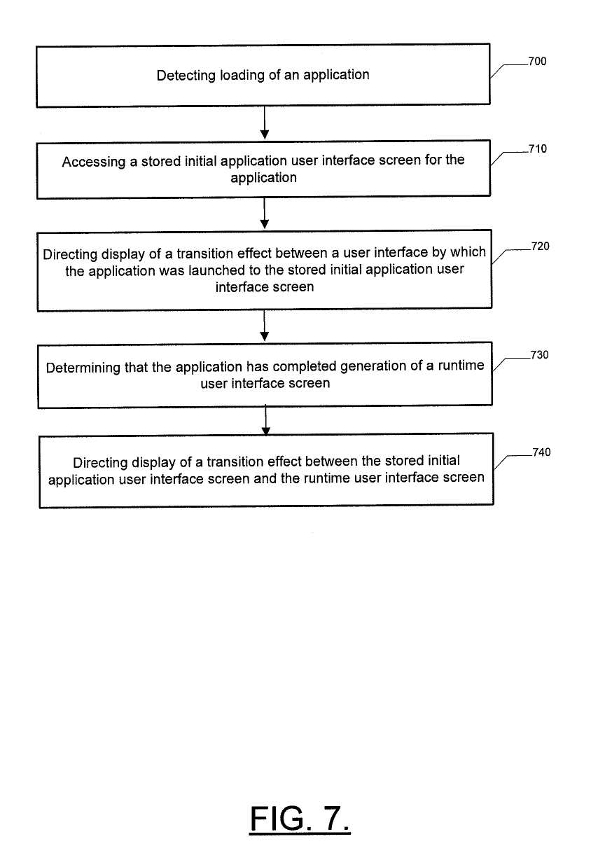

FIG. 7 illustrates a flowchart according to an example method for improving application startup according to an example embodiment of the invention. The operations illustrated in and described with respect to FIG. 7 may, for example, be performed by and/or under the control of the loading management circuitry 218. Operation 700 may comprise detecting loading of an application. Operation 710 may comprise accessing a stored initial application user interface screen for the application. Operation 720 may comprise directing display of a transition effect between a user interface by which the application was launched to the stored initial application user interface screen. Operation 730 may comprise determining that the application has completed generation of a runtime user interface screen. Operation 740 may comprise directing display of a transition effect between the stored initial application user interface screen and the runtime user interface screen.

FIGS. 5-7 are flowcharts of a system, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device and executed by a processor in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (e.g., an apparatus 202) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to computing devices and computing device users. Embodiments of the invention provide for determination and storage of an initial application user interface screen generated by an application when the application is first loaded. Embodiments of the invention display the stored initial application user interface screen during at least a portion of the next loading of the application. In this regard, embodiments of the invention give an application user the impression that the application is loaded more quickly. Further, earlier visualization of the initial user interface screen may orient the user to the application user interface such that the user may begin using the application more immediately when the application has become operation and its real user interface screen is displayed.

Embodiments of the invention additionally leverage the stored initial application user interface screen to make loading of an application a more seamless process. In this regard, embodiments of the invention provide for a transition effect, such as, for example, crossfading, between the stored initial application user interface screen and a runtime user interface screen generated by the application when the application has completed loading. Accordingly, the application user may perceive that the application has loaded more quickly as a seamless transition between a stored initial application user interface screen and a runtime user interface may give the perception that the application was loaded and operational upon display of the stored initial application user interface screen. Thus the application loading time perceived by the application user may be reduced by some embodiments of the invention.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
determining, by loading management circuitry, in response to a first loading of an application, an initial application user interface screen generated by the application;
directing storage of the initial application user interface screen;
detecting a second loading of the application; and
directing display of the stored initial application user interface screen during at least a portion of the second loading of the application.

2. The method of claim 1, wherein determining the initial application user interface screen comprises using heuristics to identify and distinguish the initial application user interface screen from any non-user interface startup screens generated by the application prior to generation of the initial user interface screen.

3. The method of claim 1, wherein determining the initial application user interface screen comprises determining an initial application user interface screen specified by the application for use during a next loading of the application.

4. The method of claim 1, further comprising:
determining a first display orientation, the first display orientation defining an orientation of a display on which the initial application user interface screen is displayed at a time when the initial application user interface screen is determined;
directing storage of an indication of the first display orientation in association with the initial application user interface;
determining a second display orientation, the second display orientation defining an orientation of the display at a time of the second loading of the application; and
comparing the first display orientation to the second display orientation; and
wherein directing display of the stored initial application user interface screen comprises directing display of the stored initial application user interface screen when the first display orientation is the same as the second display orientation.

5. The method of claim 4, further comprising when the first display orientation is different from the second display orientation:
determining whether there is a stored initial application user interface screen associated with the second display orientation;
when there is a stored initial application user interface screen associated with the second display orientation, directing display of the stored initial application user interface screen associated with the second display orientation during at least a portion of the second loading of the application; and
when there is not a stored initial application user interface screen associated with the second display orientation:
determining a second initial application user interface screen generated by the application, the second initial application user interface screen being generated by the application during or following the second loading of the application; and
directing storage of the second initial application user interface screen in association with an indication of the second display orientation.

6. The method of claim 1, wherein directing display of the stored initial application user interface screen comprises directing display of a transition effect between a user interface by which the application was launched and the stored initial application user interface screen.

7. The method of claim 1, further comprising:
determining that the application has completed generation of a runtime user interface screen; and
directing display of a transition effect between the stored initial application user interface screen and the runtime user interface screen.

8. The method of claim 1, further comprising:
determining a second initial application user interface screen generated by the application, the second initial application user interface screen being generated by the application during or following the second loading of the application; and
updating the stored initial application user interface by replacing the stored initial application user interface with the second initial application user interface screen.

9. An apparatus comprising at least one processor and at least one memory storing computer program code, wherein the at least one memory and stored computer program code are configured to, with the at least one processor, cause the apparatus to at least:
determine, in response to a first loading of an application, an initial application user interface screen generated by the application;
direct storage of the initial application user interface screen;
detect a second loading of the application; and
direct display of the stored initial application user interface screen during at least a portion of the second loading of the application.

10. The apparatus of claim 9, wherein the at least one memory and stored computer program code are configured to, with the at least one processor, cause the apparatus to determine the initial application user interface screen by using heuristics to identify and distinguish the initial application user interface screen from any non-user interface startup screens generated by the application prior to generation of the initial user interface screen.

11. The apparatus of claim 9, wherein the at least one memory and stored computer program code are configured to, with the at least one processor, cause the apparatus to determine the initial application user interface screen by determining an initial application user interface screen specified by the application for use during a next loading of the application.

12. The apparatus of claim 9, wherein the at least one memory and stored computer program code are configured to, with the at least one processor, further cause the apparatus to:
determine a first display orientation, the first display orientation defining an orientation of a display on which the initial application user interface screen is displayed at a time when the initial application user interface screen is determined;
direct storage of an indication of the first display orientation in association with the initial application user interface;
determine a second display orientation, the second display orientation defining an orientation of the display at a time of the second loading of the application; and
compare the first display orientation to the second display orientation; and
wherein the at least one memory and stored computer program code are configured to, with the at least one processor, cause the apparatus to direct display of the stored initial application user interface screen by directing display of the stored initial application user interface screen when the first display orientation is the same as the second display orientation.

13. The apparatus of claim 12, wherein, when the first display orientation is different from the second display orientation, the at least one memory and stored computer program code are configured to, with the at least one processor, further cause the apparatus to:
determine whether there is a stored initial application user interface screen associated with the second display orientation;
when there is a stored initial application user interface screen associated with the second display orientation, direct display of the stored initial application user interface screen associated with the second display orientation during at least a portion of the second loading of the application; and
when there is not a stored initial application user interface screen associated with the second display orientation:
determine a second initial application user interface screen generated by the application, the second initial application user interface screen being generated by the application during or following the second loading of the application; and
direct storage of the second initial application user interface screen in association with an indication of the second display orientation.

14. The apparatus of claim 9, wherein the at least one memory and stored computer program code are configured to, with the at least one processor, cause the apparatus to direct display of the stored initial application user interface screen by directing display of a transition effect between a user interface by which the application was launched and the stored initial application user interface screen.

15. The apparatus of claim 9, wherein the at least one memory and stored computer program code are configured to, with the at least one processor, further cause the apparatus to:
determining that the application has completed generation of a runtime user interface screen; and
directing display of a transition effect between the stored initial application user interface screen and the runtime user interface screen.

16. The apparatus of claim 9, wherein the at least one memory and stored computer program code are configured to, with the at least one processor, further cause the apparatus to:
determine a second initial application user interface screen generated by the application, the second initial application user interface screen being generated by the application during or following the second loading of the application; and
update the stored initial application user interface by replacing the stored initial application user interface with the second initial application user interface screen.

17. The apparatus of claim 9, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

18. A computer program product comprising at least one computer-readable storage medium having computer-readable program instructions stored therein, the computer-readable program instructions comprising:
program instructions configured to determine, in response to a first loading of an application, an initial application user interface screen generated by the application;
program instructions configured to direct storage of the initial application user interface screen;
program instructions configured to detect a second loading of the application; and
program instructions configured to direct display of the stored initial application user interface screen during at least a portion of the second loading of the application.

19. The computer program product of claim 18, wherein the program instructions configured to wherein the program instructions configured to determine the initial application user interface screen comprise program instructions configured to use heuristics to identify and distinguish the initial application user interface screen from any non-user interface startup screens generated by the application prior to generation of the initial user interface screen.

20. The computer program product of claim 18, further comprising:
program instructions configured to determine a first display orientation, the first display orientation defining an orientation of a display on which the initial application user interface screen is displayed at a time when the initial application user interface screen is determined;
program instructions configured to direct storage of an indication of the first display orientation in association with the initial application user interface;
program instructions configured to determine a second display orientation, the second display orientation defining an orientation of the display at a time of the second loading of the application; and
program instructions configured to compare the first display orientation to the second display orientation; and
wherein the program instructions configured to direct display of the stored initial application user interface screen comprises program instructions configured to direct display of the stored initial application user interface screen when the first display orientation is the same as the second display orientation.
